(19) United States
(12) Patent Application Publication
(10) Pub. No.: US 2025/0128425 A1
(43) Pub. Date: Apr. 24, 2025

(54) ROBOT APPARATUS AND CONTROL METHOD THEREFOR

(71) Applicant: SONY GROUP CORPORATION, TOKYO (JP)

(72) Inventors: TETSURO GOTO, TOKYO (JP); KEN KOBAYASHI, TOKYO (JP); HAYATO HASEGAWA, TOKYO (JP); YOSHIAKI SAKAKURA, TOKYO (JP); MANAMI MIYAWAKI, TOKYO (JP); KEI TSUKAMOTO, TOKYO (JP)

(21) Appl. No.: 18/689,124

(22) PCT Filed: Mar. 3, 2022
(86) PCT No.: PCT/JP2022/009196

§ 371 Date: Mar. 5, 2024

(30) Foreign Application Priority Data
Sep. 22, 2021 (JP) 2021-154873

(51) Int. Cl. B25J 13/08; B25J 15/00; B25J 15/12

(52) U.S. Cl. CPC B25J 13/084; B25J 15/0009; B25J 15/12

(57) ABSTRACT

A robot apparatus according to an embodiment of the present technology includes a hand part, a plurality of sensor parts, and a control apparatus. The hand part with a plurality of finger parts is capable of holding a workpiece. The plurality of sensor parts is respectively provided to the plurality of finger parts. The plurality of sensor parts respectively has first detection regions capable of detecting pressure components parallel to a first axis direction which is a holding direction for the workpiece and second detection regions capable of detecting pressure components parallel to a second axis direction intersecting with the first axis direction. The control apparatus is configured to generate a control command for controlling the hand part on the basis of outputs from the plurality of sensor parts.

### TECHNICAL FIELD

The present technology relates to a robot apparatus including a hand part and a control method therefor.

### BACKGROUND ART

For example, in a factory/store, when an object to be held (hereinafter, also referred to as a workpiece) placed on a work table is picked up by a robot hand, it is necessary to accurately arrange the robot hand at a reference height position (hereinafter, also referred to as a Z-position) from a placement surface of the workpiece before starting a series of operations of lowering and holding the workpiece. One of examples of a positioning method to the Z-position is a method of determining the Z-position of the robot hand by using such a jig that a workpiece is fixed every time precisely at the same position for example. However, since it is necessary to remake a jig and reset the Z-position every time specifications of the workpiece change, there is a problem in that working has to be suspended for this.

On the other hand, for example, Patent Literature 1 has proposed a method in which in order to detect a suitable Z-position, a three-dimensional position-attitude Z-position of a workpiece is recognized on the basis of a comparison result of three-dimensional position-attitude data of a workpiece acquired by a two-dimensional laser displacement sensor and a three-dimensional model of the workpiece, a manipulator is lowered from a Z-direction in relation to the recognized workpiece, and the workpiece is held.

Moreover, Patent Literature 2 has disclosed a method in which a first omnidirectional imaging device provided at a tip end of a finger part of a hand part and a second omnidirectional imaging device provided at a position other than the tip end of the finger part of the hand part and having an imaging axis different from that of the first omnidirectional imaging device and the hand part is positioned on the basis of the first and second omnidirectional imaging devices.

### CITATION LIST

### Patent Literature

Patent Literature 1: Japanese Patent Application Laid-open No. 2010-207989
Patent Literature 2: Japanese Patent Application Laid-open No. 2012-152870

### DISCLOSURE OF INVENTION

### Technical Problem

However, with the technology of Patent Literature 1, it is necessary to arrange various sensors such as two-dimensional laser displacement sensors in a working environment, and therefore there is a problem in that the fixed working environment makes lay-out changes and the like difficult and the space efficiency is also bad. Moreover, with the technology of Patent Literature 2, arithmetic processing at subsequent stages, such as image processing, becomes complicated, and therefore there is a problem in that it contributes to increases in calculation cost and latency.

In view of the above-mentioned circumstances, it is an objective of the present technology to provide a robot apparatus and a control method therefor that can suitably hold a workpiece with a simple sensor configuration without being limited by a working environment.

### Solution to Problem

A robot apparatus according to an embodiment of the present technology includes a hand part, a plurality of sensor parts, and a control apparatus.

The hand part with a plurality of finger parts is capable of holding a workpiece.

The plurality of sensor parts is respectively provided to the plurality of finger parts. The plurality of sensor parts respectively has first detection regions capable of detecting pressure components parallel to a first axis direction which is a holding direction for the workpiece and second detection regions capable of detecting pressure components parallel to a second axis direction intersecting with the first axis direction.

The control apparatus is configured to generate a control command for controlling the hand part on the basis of outputs from the plurality of sensor parts.

In accordance with such a robot apparatus, the operation of the hand part is controlled on the basis of the pressure components in the respective axis directions detected by the sensor parts provided to the respective finger parts, and therefore it is possible to suitably hold the workpiece with a simple sensor configuration without being limited by a working environment.

The plurality of finger parts may respectively have flat surface or curved surface-shaped tip end regions positioned at finger tips and flat surface or curved surface-shaped holding regions that hold the workpiece. In this case, the first detection regions are respectively arranged at the tip end regions of the plurality of finger parts and the second detection regions are respectively arranged at the holding regions of the plurality of finger parts.

At least one of the plurality of finger parts may be configured to be capable of turning around a third axis orthogonal to each of the first axis and the second axis.

The plurality of sensor parts may be respectively constituted by common sensor sheets having the first detection regions and the second detection regions in a plane.

The sensor sheet may be constituted by a pressure sensor including a sensor electrode layer having a plurality of capacitive elements arranged in a matrix form, a reference electrode layer connected to a reference potential, and a deformation layer arranged between the sensor electrode layer and the reference electrode layer.

Alternatively, the sensor sheet may include a pair of pressure sensors with the above-mentioned configuration and a separation layer constituted by a viscoelastic material arranged between the pair of pressure sensors.

The control apparatus may be configured to output a control command for controlling a movement of the hand part along the second axis direction on the basis of the outputs from the second detection regions.

The control command may be a control command for stopping the movement of the hand part along the second axis direction as the control command.

Alternatively, the control command may be a control command for changing a movement velocity of the hand part along the second axis direction as the control command.

The control apparatus may be configured to output, when pressure values detected by the second detection regions in the plurality of finger parts are equal to or larger than a predetermined threshold, a control command for controlling an attitude of the hand part so that a difference between the pressure values detected by the second detection regions in the plurality of finger parts is equal to or smaller than a predetermined value.

The control apparatus may be configured to output a control command for moving the plurality of finger parts along the first axis direction while maintaining a state in which the difference between the pressure values detected by the second detection regions in the plurality of finger parts is equal to or smaller than the predetermined value.

The control apparatus may be configured to output a control command for raising the hand part when pressure values detected by the first detection regions between the plurality of finger parts are equal to or larger than a predetermined threshold.

The control apparatus may be configured to output, when the pressure values detected by the first detection regions between the plurality of finger parts are equal to or larger than a predetermined threshold, a control command for turning one finger part of the plurality of finger parts around a third axis orthogonal to each of the first axis and the second axis.

A control method for a robot apparatus according to an embodiment of the present technology is a control method for a robot apparatus including a hand part with a plurality of finger parts capable of holding a workpiece, a plurality of sensor parts that is respectively provided to the plurality of finger parts and respectively has first detection regions capable of detecting pressure components parallel to a first axis direction which is a holding direction for the workpiece and second detection regions capable of detecting pressure components parallel to a second axis direction intersecting with the first axis direction, and a control apparatus that controls an operation of the hand part on the basis of outputs from the plurality of sensor parts and includes:
moving the hand part in the second axis direction; and
controlling a movement of the hand part along the second axis direction on the basis of the outputs from the second detection regions.

The step of controlling the movement of the hand part may include stopping the movement of the hand part along the second axis direction.

Alternatively, the step of controlling the movement of the hand part may include changing a movement velocity of the hand part along the second axis direction.

The control method for a robot apparatus may include controlling, when pressure values detected by the second detection regions in the plurality of finger parts are equal to or larger than a predetermined threshold, an attitude of the hand part so that a difference between the pressure values detected by the second detection regions in the plurality of finger parts is equal to or smaller than a predetermined value.

The control method for a robot apparatus may include moving the plurality of finger parts along the first axis direction while maintaining a state in which the difference between the pressure values detected by the second detection regions in the plurality of finger parts is equal to or smaller than the predetermined value.

The control method for a robot apparatus may include raising the hand part when pressure values detected by the first detection regions between the plurality of finger parts are equal to or larger than a predetermined threshold.

Alternatively, the control method for a robot apparatus may include turning, when the pressure values detected by the first detection regions between the plurality of finger parts are equal to or larger than a predetermined threshold, one finger part of the plurality of finger parts around a third axis orthogonal to each of the first axis and the second axis.

### BRIEF DESCRIPTION OF DRAWINGS

FIG. 1 A perspective view of main parts showing a robot apparatus according to an embodiment of the present technology.

FIG. 2 A schematic side cross-sectional view showing a cross-sectional structure of a sensor sheet which is a configuration example of a sensor part in the robot apparatus.

FIG. 3 A schematic plan view showing a sensor electrode layer in the sensor sheet.

FIG. 4 A main part plan showing a configuration example of a sensing part in the sensor sheet.

FIG. 5 A schematic side cross-sectional view showing another configuration example of the sensor part.

FIG. 6 A main-part front view of a hand part showing an arrangement example of the sensor part with respect to finger parts in the robot apparatus.

FIG. 7 An explanatory diagram of a pressure detection surface of the sensor part.

FIG. 8 A block diagram showing a configuration of a control unit in the sensor part.

FIG. 9 A block diagram showing an example of a control system of the robot apparatus.

FIG. 10 A main-part front view showing a procedure of an operation example of the robot apparatus.

FIG. 11 A flowchart showing an example of a processing procedure of a control apparatus that executes the operation in FIG. 10.

FIG. 12 A flowchart showing an example of the processing procedure of the control apparatus that executes the operation in FIG. 10.

FIG. 13 A schematic view describing another operation example of the robot apparatus.

FIG. 14 A flowchart showing an example of the processing procedure of the control apparatus that executes the operation in FIG. 13.

FIG. 15 A schematic front view showing a configuration of a hand part of a robot apparatus according to a second embodiment of the present technology.

FIG. 16 A main-part front view showing a procedure of an operation example of the robot apparatus.

FIG. 17 A flowchart showing an example of a processing procedure of a control apparatus that executes the operation in FIG. 16.

FIG. 18 A schematic front view of main parts showing another configuration example of the hand part of the robot apparatus.

### MODE(S) FOR CARRYING OUT THE INVENTION

Hereinafter, embodiments according to the present technology will be described with reference to the drawings.

### First Embodiment

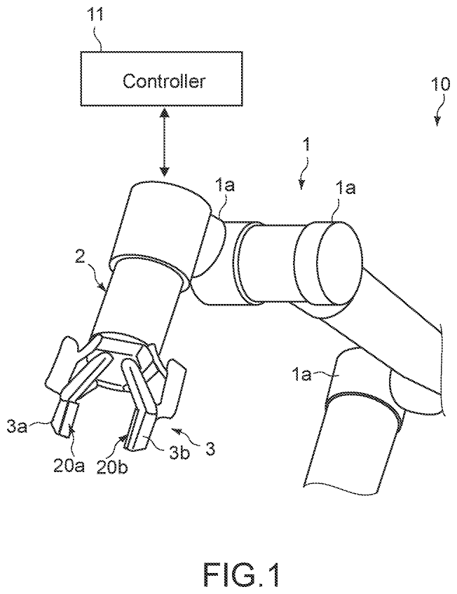

FIG. 1 is a perspective view main parts of showing a robot apparatus 10 according to an embodiment of the present technology. In the present embodiment, the robot apparatus 10 constitutes a robot hand. Hereinafter, a configuration of the robot apparatus 10 will be schematically described.

### [Robot Apparatus]

As shown in FIG. 1, the robot apparatus 10 includes an arm part 1, a wrist part 2, and a hand part 3.

The arm part 1 includes a plurality of joint parts 1a. Driving of the joint parts 1a enables the hand part 3 to move to any position. The wrist part 2 is rotatably connected to the arm part 1. The rotation of the wrist part 2 enables rotation of the hand part 3.

The hand part 3 has a plurality of finger parts capable of holding an object to be held (workpiece). In the present embodiment, the hand part 3 includes two finger parts 3a and 3b that face each other and is capable of holding the workpiece between the two finger parts 3a and 3b by driving the two finger parts 3a and 3b. It should be noted that the number of finger parts can be modified as appropriate (e.g., three or four or more).

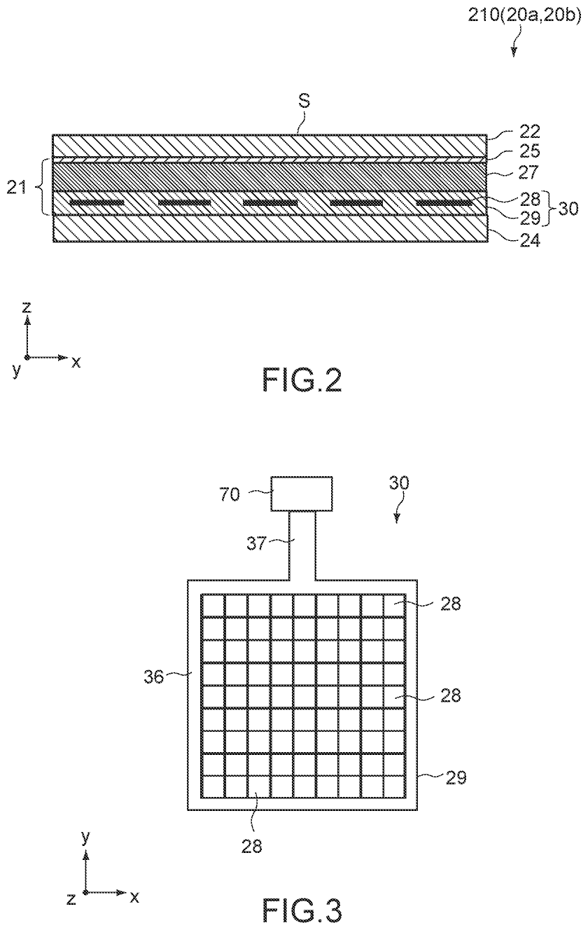

Surfaces of the two finger parts 3a and 3b which face each other are respectively provided with sensor parts 20a and 20b. The sensor parts 20a and 20b includes pressure detection surfaces and are configured to be capable of detecting pressure components added in a direction perpendicular to the pressure detection surfaces and their in-plane distributions. Moreover, the sensor parts 20a and 20b may be 3-axis sensors capable of detecting not only the pressure distributions, but also shearing forces parallel to the pressure detection surfaces and their in-plane distribution. It should be noted that configurations of the sensor parts 20a and 20b will be described later with reference to FIG. 2, etc.

The robot apparatus 10 is driven by control of a controller 11. The controller 11 includes a control part, a storage part, and the like. The control part is, for example, a central processing unit (CPU) and controls driving of the respective parts in the robot apparatus 10 on the basis of the program stored in the storage part. The controller 11 may be a dedicated apparatus for the robot apparatus 10 or may be a universal apparatus. The controller 11 may be, for example, a personal computer (PC) connected to the robot apparatus 10 with a wire or wirelessly or a server apparatus in a network. The controller 11 may be configured as a part of the robot apparatus 10.

### [Sensor Part]

Subsequently, details of the sensor parts 20a and 20b will be described. The sensor parts 20a and 20b have configurations identical to each other. The sensor parts 20a and 20b are constituted by sensor sheets capable of detecting pressure distributions on the pressure detection surfaces as described above.

### (Configuration Example 1)

FIG. 2 is a schematic side cross-sectional view showing a cross-sectional structure of a sensor sheet 210 which is a configuration example of each of the sensor parts 20a and 20b. FIG. 3 is a schematic plan view showing a sensor electrode layer 30 in the sensor sheet 210.

In FIGS. 2 and 3, an x-axis direction and a y-axis direction are directions parallel to a pressure detection surface S in the sensor sheet 210 (hereinafter, also referred to as an in-plane direction) and the z-axis direction is a direction perpendicular to the pressure detection surface (hereinafter, also referred to as a perpendicular direction). Moreover, in FIG. 2, the upper side corresponds to a front side to which an external force is added and the lower side corresponds to a rear side of the opposite side.

The sensor sheet 210 has a flat plate shape with a rectangular shape in plan view as a whole. It should be noted that the shape of the sensor sheet 210 in plan view only needs to be set as appropriate in accordance with the shape at a position where the sensor part 20a or 20b is arranged and the shape of the sensor sheet 210 in plan view is not particularly limited. For example, the shape of the sensor sheet 210 in plan view may be a polygonal shape, a circular shape, or an elliptical shape other than the rectangular shape.

As shown in FIG. 2, the sensor sheet 210 is constituted by a laminate including a pressure sensor 21, a surface layer 22 arranged on an upper surface of the pressure sensor 21, and a supporting layer 24 arranged on a lower surface of the pressure sensor 21.

The pressure sensor 21 includes the sensor electrode layer 30, a reference electrode layer 25, and a deformation layer 27 arranged between the sensor electrode layer 30 and the reference electrode layer 25.

The sensor electrode layer 30 is constituted by a flexible printed board and the like. As shown in FIG. 3, the sensor electrode layer 30 includes a main body 36 with a rectangular shape in plan view and a pull-out part 37 extended outwards from the main body 36. It should be noted that the shape of the sensor electrode layer 30 in plan view is not limited to the rectangular shape, and can be modified as appropriate.

The sensor electrode layer 30 includes a base material 29 having flexibility and a plurality of sensing parts 28 provided on or in a surface of the base material 29. The material of the base material 29 is, for example, polymer such as polyethylene terephthalate, polyimide, polycarbonate, or an acrylic resin. The sensing parts 28 are regularly arranged in a matrix form at predetermined intervals vertically and horizontally (vertical: the y-axis direction, horizontal: the x-axis direction). In the example shown in FIG. 3, the number of sensing parts 28 is 9*9 (vertical*horizontal)=81. It should be noted that the number of sensing parts 28 can be modified as appropriate.

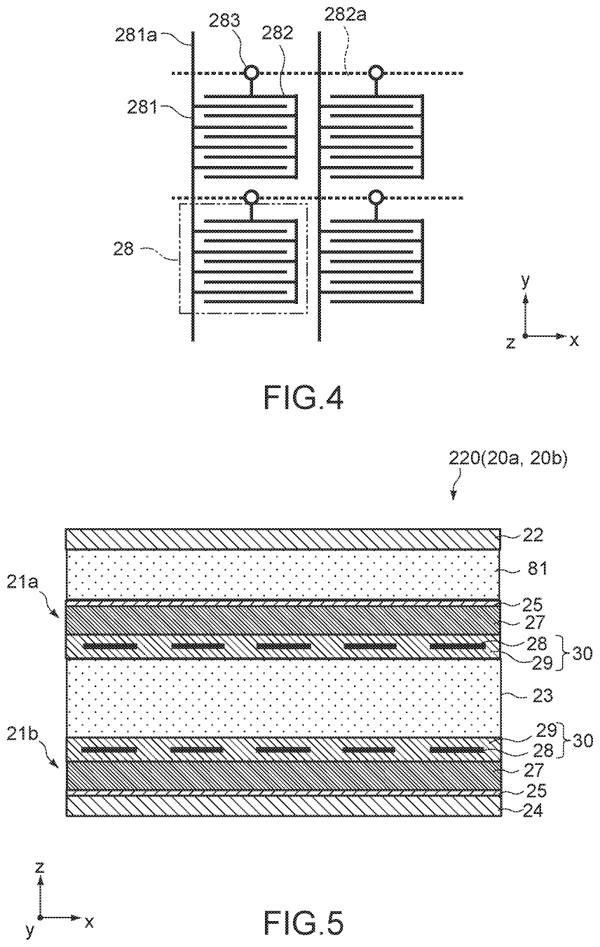

The sensing parts 28 are constituted by capacitive elements (detection elements) capable of detecting changes in distance from the reference electrode layer 25 as changes in capacitance. For example, as shown in FIG. 4, the sensing parts 28 include comb teeth-shaped pulse electrodes 281 and comb teeth-shaped sensing electrodes 282. The comb teeth-shaped pulse electrodes 281 and the comb teeth-shaped sensing electrodes 282 are arranged so that the comb teeth face each other and each sensing part 28 is constituted by a region (node area) in which one comb teeth are arranged to get in between the other comb teeth. Each pulse electrode 281 is connected to a wiring part 281a extending in the y-axis direction and each sensing electrode 281 is connected to a wiring part 282a extending in the x-axis direction. The wiring part 281a is arranged in the x-axis direction on the surface of the base material 29 and the wiring part 282a is arranged in the y-axis direction on the back surface of the base material 29. Each sensing electrode 282 is electrically connected to the wiring part 282a via through-holes 283 provided in the base material 29. The sensor electrode layer 30 may include ground wires. The ground wires are provided in, for example, an outer peripheral portion of the sensor electrode layer 30 or a portion where the wiring parts 281a and 282a run in parallel.

It should be noted that the structures of the sensing parts 28 are not limited to the above-mentioned example, and any structure may be used. For example, the sensor electrode layer 30 may be constituted by a laminate of a first electrode sheet having a grid-like first electrode pattern extending in the x-axis direction and a second electrode sheet having a grid-like second electrode pattern extending in the y-axis direction. In this case, the sensing part 28 is formed at an intersecting portion of the first electrode pattern and the second electrode pattern.

The reference electrode layer 25 is connected to a reference potential. In the present embodiment, the reference electrode layer 25 is a so-called grounding electrode and is connected to a ground potential. The reference electrode layer 25 has flexibility and its thickness is, for example, approximately 0.05 μm to 0.5 μm. The material of the reference electrode layer 25 is, for example, an inorganic electrically conductive material, an organic electrically conductive material, or an electrically conductive material including both an inorganic electrically conductive material and an organic electrically conductive material.

Examples of the inorganic electrically conductive material include metals such as aluminum, copper, and silver, alloys such as a stainless steel, and a metal oxide such as a zinc oxide and an indium oxide. Moreover, examples of the organic electrically conductive material include carbon materials such as carbon black and carbon fibers and electrically conductive polymers such as substituted or non-substituted polyaniline and polypyrrole. The reference electrode layer 25 may be constituted by a metal thin plate made of stainless steel, aluminum, or the like, electrically conductive fibers, electrically conductive non-woven fabric, or the like. The reference electrode layer 25 may be formed on a plastic film by a method, for example, vapor deposition, sputtering, adhesion, or application.

The deformation layer 27 is arranged between the sensor electrode layer 30 and the reference electrode layer 25. The deformation layer 27 has a thickness of, for example, approximately 100 μm to 1000 μm. The deformation layer 27 is configured to be elastically deformable in accordance with the external force. When the external force is added in a direction perpendicular to the sensor sheet 210, the reference electrode layer 25 approaches the sensor electrode layer 30 while the deformation layer 27 is elastically deformed in accordance with an external force. At this time, since a capacitance between the pulse electrode 281 and the sensing electrode 282 changes in the sensing part 28, the sensing part 28 is capable of detecting this change in capacitance as a pressure value.

The thickness of the deformation layer 27 is, for example, set to be more than 100 μm and 1000 μm or less. The weight per unit area of the deformation layer 27 is, for example, set to be 50 mg/cm² or less. By setting the thickness of the deformation layer 27 and the weight per unit area within this range, detection sensitivity of the pressure sensor 22 in the perpendicular direction can be enhanced.

Although a lower limit value of the thickness of the deformation layer 27 is not particularly limited as long as it is larger than 100 μm, this lower limit value may be, for example, 150 μm or more, 200 μm or more, 250 μm or more, or 300 μm or more. Moreover, although an upper limit value of the thickness of the deformation layer 27 is not particularly limited as long as it is 1000 μm or less, this upper limit value may be, for example, 950 μm or more, 900 μm or less, 850 μm or less, or 800 or less.

In order to be easily deformed in the z-axis direction, the deformation layer 27 may be configured with a patterning structure including a column structure, for example. Various structures such as a matrix shape, a stripe shape, a mesh shape, a radial shape, a geometric shape, and a spiral shape can be employed for this patterning structure.

The surface layer 22 is constituted by any material such as a plastic film, woven fabric, non-woven fabric, a rubber, or a leather having flexibility. The surface layer 22 may be configured as a contact surface that comes into contact with the workpiece when the robot apparatus 10 holds the workpiece by the finger parts 3a and 3b. In this case, since the surface layer 22 functions as a pressure detection surface that receives a load (reaction force of a holding force) received from the workpiece during the holding operation, the surface layer 22 is favorably one having a surface feature that a predetermined value or more of a frictional force with the workpiece is obtained in order to stably hold the workpiece.

The supporting layer 24 supports the pressure sensor 21. For example, the supporting layer 24 functions as a bonding layer to be fixed to the surface of the finger part 3a or 3b. The supporting layer 24 is, for example, constituted by an adhesive layer such as a double sided tape.

A control unit 70 is mounted on the pull-out part 37 of the sensor electrode layer 30. The control unit 70 calculates a force in the in-plane direction on the basis of information about a pressure detected by the pressure sensor 21. The control unit 70 is typically a computer including a central processing unit (CPU) and is constituted by an integrated circuit such as an IC chip. The control unit 70 is mounted on the sensor electrode layer 30 (pull-out part 37). The control unit 70 is configured to drive the pressure sensor 21. An output signal from the pressure sensor 21 is input to the control unit 70. It should be noted that the control unit 70 is not limited to the example in which it is mounted on the sensor electrode layer 30.

### (Configuration Example 2)

FIG. 5 is a schematic side cross-sectional view showing a cross-sectional structure of a sensor sheet 220 which is another configuration example of each of the sensor parts 20a and 20b. It should be noted that portions corresponding to those of Configuration Example 1 will be denoted by the same reference signs and detailed descriptions thereof will be omitted.

The sensor sheet 220 includes a first pressure sensor 21a on a front side (workpiece side), a second pressure sensor 21b on a rear side (finger part 3a or 3b side), and a separation layer 23 arranged between the first pressure sensor 21a and the second pressure sensor 21b. That is, the sensor sheet 220 has a structure in which the second pressure sensor 21b, the separation layer 23, and the first pressure sensor 21a are stacked in order from a lower layer side in the perpendicular direction. The first pressure sensor 21a and the second pressure sensor 21b have configurations similar or substantially similar to the pressure sensor 21, and therefore their descriptions will be omitted.

The sensor sheet 220 further includes a viscoelastic body layer 81 arranged on the upper side (surface side) of the first pressure sensor 21a. The viscoelastic body layer 81 is constituted by a material deformable in accordance with an external force, for example, a silicon gel, a urethane gel, a synthetic rubber, or a foam. It should be noted that the viscoelastic body layer 81 may be omitted depending on needs. The sensor sheet 220 detects a force (shearing force Fs) added to the sensor sheet 220 in the in-plane direction on the basis of a pressure center position (pressure detection position) in the in-plane direction by the first pressure sensor 21a and a pressure center position (pressure detection position) in the in-plane direction by the second pressure sensor 21b. Moreover, the sensor sheet 220 detects a force (load Fz) added from an upper side in a direction perpendicular to the sensor sheet 220 on the basis of a value of the pressure detected by the first pressure sensor 21a.

The separation layer 23 is fixed between the first pressure sensor 21a and the second pressure sensor 21b via the adhesive layer (not shown). The separation layer 23 is constituted by a viscoelastic material deformed by a load added to the first pressure sensor 21a via the surface layer 22 and the viscoelastic body layer 81. Examples of this type of viscoelastic material include a silicon gel, a urethane gel, a synthetic rubber, and a foam. The thickness of the separation layer 23 is not particularly limited. For example, the thickness of the separation layer 23 is set to be 1000 μm or more and 5000 μm or less and is set in accordance with the thickness and the like of the viscoelastic body layer 81. The shape of the separation layer 23 in plan view is not particularly limited, and is typically a rectangular or circular shape.

### [Arrangement Example of Sensor Part]

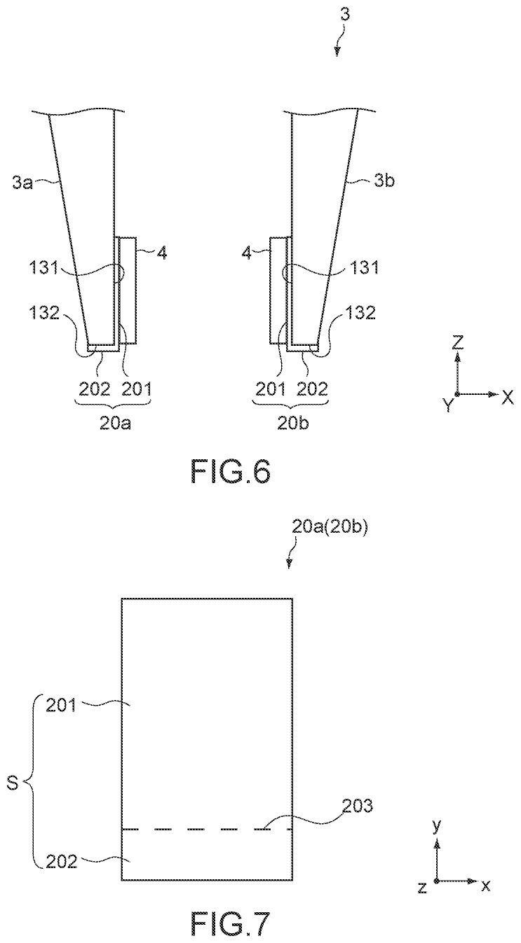

FIG. 6 is a main-part front view of the hand part 3 showing an arrangement example of the sensor parts 20a and 20b with respect to the finger parts 3a and 3b. FIG. 7 is an explanatory diagram of the pressure detection surface S of the sensor part 20a or 20b.

In FIG. 6, the X-axis, the Y-axis, and the Z-axis show three axis directions orthogonal to one another and the Z-axis corresponds to the upper and lower directions. It should be noted that the X-axis, the Y-axis, and the Z-axis respectively correspond to the z-axis, the x-axis, and the y-axis of the sensor parts 20a and 20b (the sensor sheets 210 and 220) described above with reference to FIGS. 2 to 5.

As shown in FIG. 6, the finger parts 3a and 3b respectively have holding regions 131 that hold the workpiece and tip end regions 132 positioned at the finger tips.

The holding regions 131 are regions that come into contact with the workpiece when sandwiching the workpiece between the finger parts 3a and 3b. Typically, the holding regions 131 correspond to balls of the finger parts 3a and 3b. The holding regions 131 are provided at positions facing each other in an X-axis direction (first axis direction) which is a holding direction for the workpiece in the respective finger parts 3a and 3b. The shape of the holding region 131 varies depending on the shape, the structure, and the like of the finger part 3a or 3b. Typically, the holding region 131 is formed in a flat surface shape or a curved surface shape.

On the other hand, the tip end regions 132 are the tip end portions of the finger parts 3a and 3b and are formed at the same height positions of the respective finger parts 3a and 3b, i.e., regions positioned on the same plane parallel to the XY-plane. The shape of the tip end region 132 also varies depending on the shape, the structure, and the like of the finger part 3a or 3b. Typically, the tip end region 132 is formed in a flat surface shape or a curved surface shape.

It should be noted that the two finger parts 3a and 3b may be both configured to be synchronously movable in a direction to approach each other or be spaced away from each other in the X-axis direction or one finger part may be configured to be movable to the other finger part in the X-axis direction. Moreover, as will be described later, at least one finger part of the finger parts 3a and 3b may include a joint part that turns the finger tip around the Y-axis.

On the other hand, as shown in FIG. 7, in the sensor part 20a or 20b, the pressure detection surface S is divided into a first detection region 201 and a second detection region 202. The first detection region 201 and the second detection region 202 have similar layer structures and the plurality of sensing parts 28 is arranged in each plane.

Then, the sensor part 20a or 20b is configured to be bendable at a boundary 203 between the first detection region 201 and the second detection region 202 so that the first detection region 201 is arranged in the holding region 131 of the finger part 3a or 3b and the second detection region 202 is arranged in the tip end region 132 of the finger part 3a or 3b. For easily bending at the boundary 203, a perforation or a slit may be formed along the boundary 203 or the boundary 203 may be formed with a smaller thickness than other regions.

As will be described later, the first detection regions 201 of the sensor parts 20a and 20b arranged on the finger parts 3a and 3b are regions for detecting a holding force with respect to the workpiece. On the other hand, the second detection regions 202 of the sensor parts 20a and 20b arranged on the finger parts 3a and 3b have pressure detection axes in a direction (Z-axis) intersecting with (in this example, orthogonal to) a pressure detection axis (X-axis) of the first detection region 201. As will be described later, the second detection region 202 is a region for detecting a placement surface where the workpiece is placed and a contact with the workpiece itself at the time of lowering or horizontal movement of the hand part 3. The plurality of sensing parts 28 is respectively distributed in the plane and arranged in the first detection region 201 and the second detection region 202, and therefore a holding attitude of the workpiece, attitudes of the finger parts 3a and 3b with respect to the workpiece or the placement surface on which the workpiece is placed can be determined on the basis of distributions of pressures detected by the respective detection regions.

In the present embodiment, the sensor parts 20a and 20b are respectively constituted by the common sensor sheets 210 and 220 having the first detection regions 201 and the second detection regions 202 in the plane. Therefore, it is possible to reduce the number of sensor parts as compared to the case where the sensor part is provided for each detection region and to commonly control the respective detection regions by the single control unit 70.

It should be noted that as shown in FIG. 6, protection layers 4 that cover the first detection region 201 are installed in the holding regions 131 of the respective finger parts 3a and 3b, and a configuration is made so that the workpiece is brought into contact with the first detection regions 201 via the protection layers 4. The protection layers 4 can be constituted by a material similar to that of the surface layers 22 of the sensor parts 20a and 20b. Moreover, installation of the protection layers 4 is optional and may be omitted depending on needs.

### [Control Apparatus]

The control unit 70 includes a control part, a storage part, and the like. The control part is, for example, a central processing unit (CPU), and driving of the respective parts in the hand part 3 is controlled by executing the program stored in the storage part on the basis of a control command from the controller 11. Typically, the control unit 70 acquires information about forces in the three axis directions detected by the sensor parts 20a and 20b and controls driving of the hand part 3 so as to stably hold the object a suitable holding force on the basis of this force information.

The storage part includes a nonvolatile memory for storing various programs and data required for the processing of the control part and a volatile memory used as a working region for the control part. The various programs may be read out from a portable recording medium of a semiconductor memory or the like or may be downloaded from a server apparatus in a network.

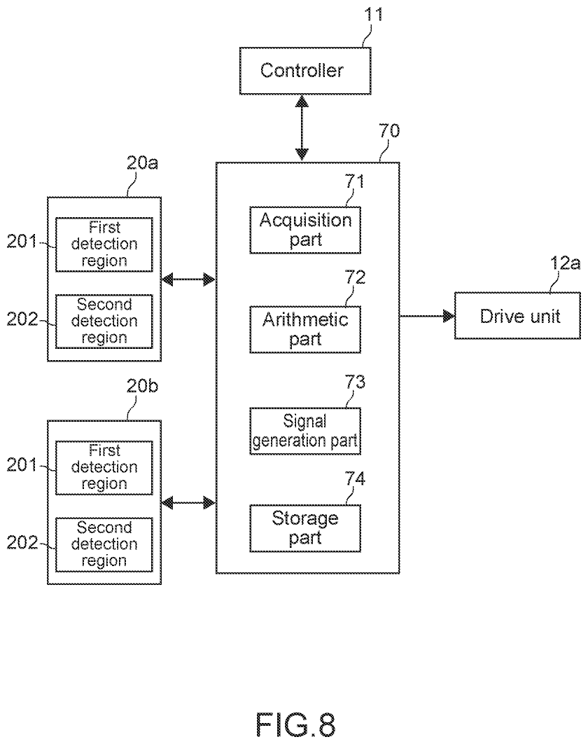

FIG. 8 is a block diagram showing a configuration of the control unit 70.

The control unit 70 is electrically connected to the sensor parts 20a and 20b. The control unit 70 is configured to calculate pressures that act on the respective finger parts 3a and 3b and their in-plane distribution on the basis of the outputs from the sensor parts 20a and 20b. The control unit 70 is further electrically connected to the controller 11 and a holding command is output to a drive unit 12a that drives the finger parts 3a and 3b of the hand part 3 on the basis of a control command from the controller 11.

The controller 11 and the control unit 70 are configured as control apparatuses that control the operation of the hand part 3. In the present embodiment, the control unit 70 generates the holding command supplied to the drive unit 12a for driving the finger parts 3a and 3b. However, instead of this, the controller 11 that controls the general operations of the robot apparatus 10 may generate the holding command. In this case, the controller 11 is configured as the above-mentioned control apparatus.

As shown in FIG. 8, the control unit 70 includes an acquisition part 71, an arithmetic part 72, a signal generation part 73, and a storage part 74.

The acquisition part 71 receives pressure detection positions and their pressure value output from the respective sensor parts 20a and 20b and a control command output from the controller 11. Pressure information including pressure detection positions and their pressure values output from the respective sensor parts 20a and 20b (the first detection regions 201 and the second detection regions 202) is information regarding stress detected when the hand parts 3 (finger parts 3a and 3b) come into contact with the workpiece or the placement surface on which the workpiece is placed and also stress that acts on the sensor parts 20a and 20b while the hand parts 3 (finger parts 3a and 30b) hold the workpiece.

The arithmetic part 72 calculates an in-plane distributions of pressures that act on the pressure detection surfaces S on the basis of pressure detection positions in the in-plane direction and their pressure values by the sensor parts 20a and 20b (the first detection regions 201 and the second detection regions 202). The load perpendicular to the pressure detection surface is calculated by the sum of perpendicular loads acquired by the respective sensing parts 28 of the sensor parts 20a and 20b (the first detection regions 201 and the second detection regions 202), for example. It should be noted that in a case where the sensor parts 20a and 20b are constituted by the sensor sheet 220 as shown in FIG. 5, a distribution of shearing forces in the in-plane direction of the pressure detection surface S is further calculated.

The signal generation part 73 generates a holding command for holding the workpiece to the hand part 3 on the basis of a control command from the controller 11. This holding command includes information regarding a holding force of the hand part 3 with respect to the workpiece. The signal generation part 73 outputs the generated holding command to the drive unit 12a of the hand part 3.

The drive unit 12a is an actuator that moves the finger parts 3a and 3b between a holding position to a non-holding position. In the present embodiment, the drive unit 12a is constituted by, for example, a pulse motor capable of fine feed control.

The storage part 74 is typically constituted by a semiconductor memory. The storage part 74 stores programs and various parameters for executing the processing procedure of calculating a distribution of the shearing force in the in-plane direction on the basis of pressure detection positions in the in-plane direction by the first pressure sensor 22a and the second pressure sensor 22b.

### [Control of Robot Apparatus]

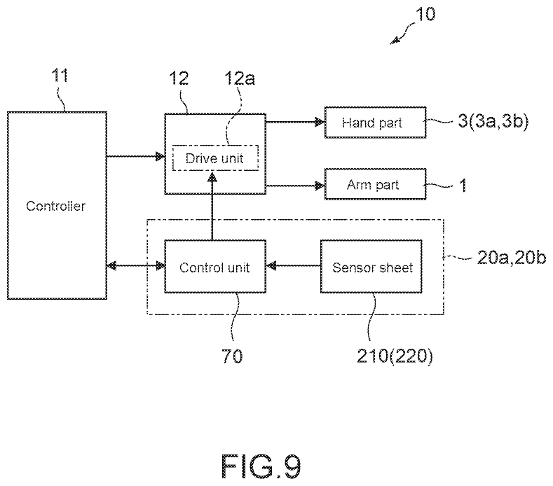

FIG. 9 is a block diagram showing an example of a control system of the robot apparatus 10. The robot apparatus 10 includes a drive part 12 that drives the controller 11, the arm part 1, the hand part 3, and the like. The drive part 12 includes the drive unit 12a that drives the finger parts 3a and 3b. The controller 11 is configured to be capable of executing a control program for operating the robot apparatus 10 on the basis of input signals from the various sensors.

The sensor parts 20a and 20b constitute one of the above-mentioned various sensors and are attached to holding surfaces of the hand part 3 for the workpiece. The sensor parts 20a and 20b output, on the basis of a control command from the controller 11, a holding command for holding the workpiece to the drive unit 12a that drives the finger parts 3a and 3b of the hand part 3. The sensor parts 20a and 20b detect pressing pressures that act on the pressure detection surfaces S (pressure distributions, holding forces (perpendicular loads) or shearing forces). Then, the control unit 70 calculates values of the pressing pressures and inputs the values to the controller 11. The controller 11 generates driving signals for controlling the positions and attitudes of the arm part 1 and the hand part 3 (the finger parts 3a and 3b) and outputs the driving signals to the drive part 12. The drive part 12 is typically an actuator such as an electric motor or a fluid pressure cylinder and drives the arm part 1, the hand part 3, and the like on the basis of the driving signals from the controller 11.

As described above, in the present embodiment, the control unit 70 is configured to execute holding control on the hand part 3. Not limited thereto, the controller 11 may directly output the holding command to the drive unit 12a and execute the holding control on the hand part 3. In this case, the control unit 70 executes only the function of computing pressures that act on the sensor parts 20a and 20b and outputting them to the controller 11.

Subsequently, details of the controller 11 and the control unit 70 and the operation of the robot apparatus 10 according to the present embodiment will be described.

### (Operation Example 1)

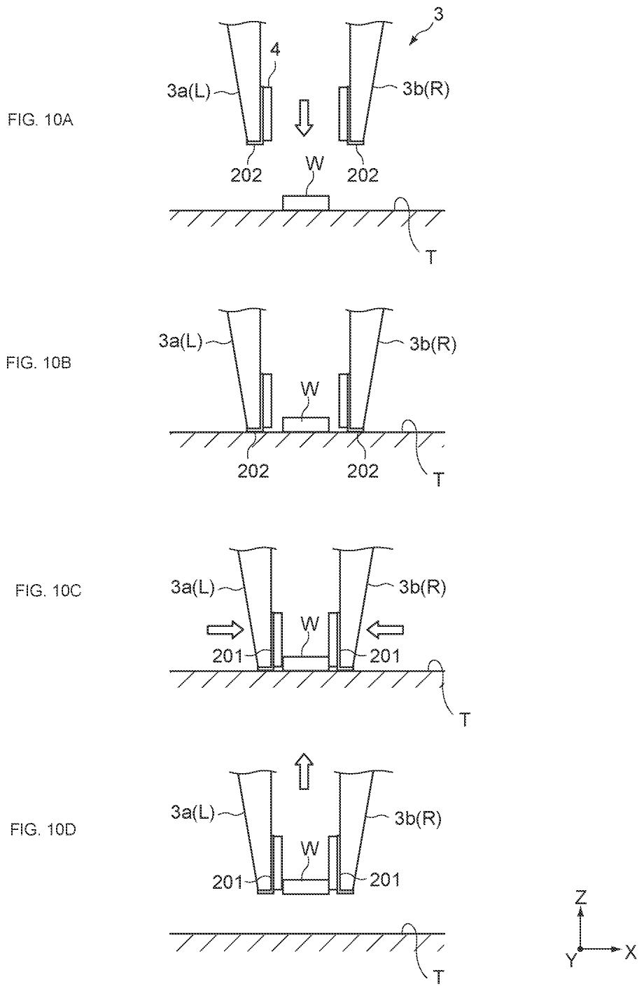

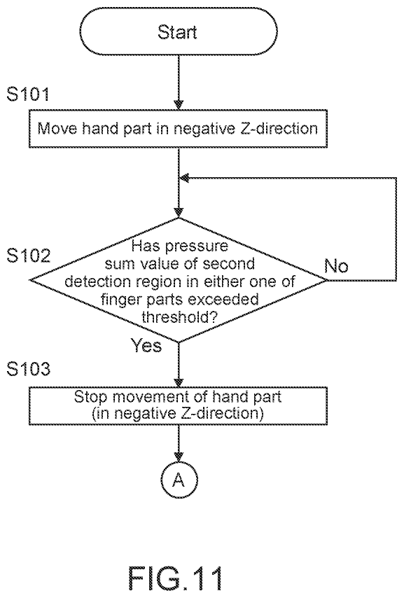

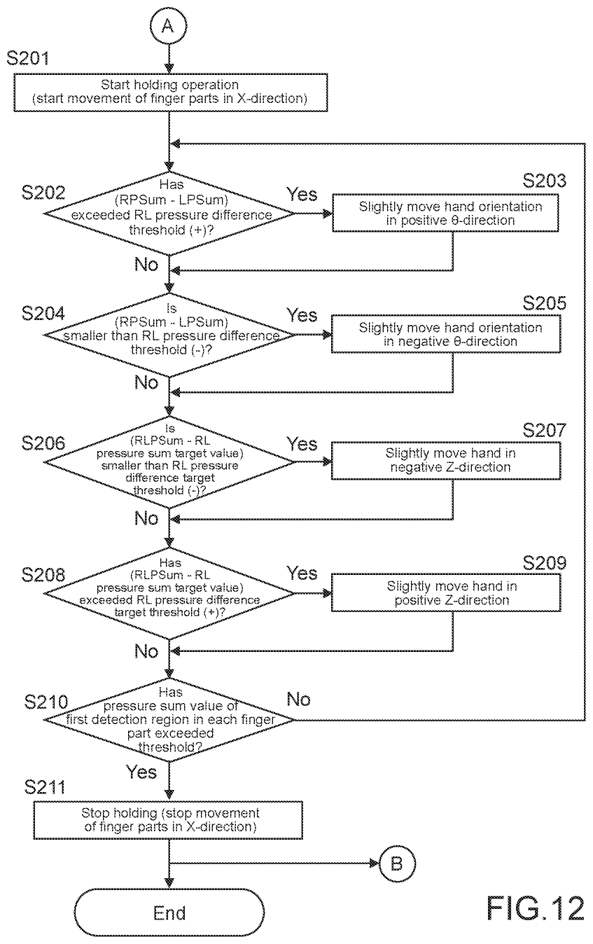

FIG. 10 is a main-part front view showing a procedure of a pickup operation of the hand part 3 with respect to a workpiece W placed on a placement surface T. FIGS. 11 and 12 are flowcharts showing examples of processing procedures executed in the control apparatus (the controller 11 and the control unit 70).

The workpiece W is arranged at a preset reference position of the placement surface T. The workpiece W may be any form such as a plate shape, a rod shape, or a columnar shape. The attitude of the workpiece W is not limited to the lying-down attitude shown in the figure, and may be a standing attitude.

On the other hand, the arm part 1 moves the hand part 3 from the placement surface T right above the above-mentioned reference position on which the workpiece W is placed to a predetermined height position (Z-position) ((A) of FIG. 10). At this time, the finger parts 3a and 3b are maintained in a vertical attitude with their tip end portions (the tip end regions 132) facing the placement surface T and set in an open position (non-holding position) in which they are spaced away from each other. In the following description, one finger part 3a will also be referred to as a left finger part (L) and the other finger part 3b will also be referred to as a right finger part (R).

As shown in (A) of FIG. 10, after the hand part 3 moves to the predetermined height position (Z-position) right above the workpiece W, the controller 11 outputs a control command for moving the hand part 3 downwards (negative Z-direction) at a predetermined velocity (Step 101).

Subsequently, the control unit 70 determines whether or not the sum of pressure values in the Z-axis direction detected by the second detection region 202 of the sensor part 20a or 20b in either one of the finger parts 3a and 3b has exceeded a predetermined threshold (Step 102). As shown in (B) of FIG. 10, either one of the finger parts 3a and 3b of the hand part 3 moving downwards (negative Z-direction) comes into contact with the placement surface T, and in a case where its contact pressure has exceeded such a threshold (“Yes” in Step 102), the controller 11 outputs a control command for stopping the movement as the control command for controlling the movement of the hand part 3 (Step 103).

Subsequently, as shown in (C) of FIG. 10, the control unit 70 outputs a holding operation start command to the hand part 3 and moves the finger parts 3a and 3b in the X-axis direction (Step 201). At this time, on the basis of outputs from the second detection regions 202 of the sensor parts 20a and 20b, the controller 11 controls the attitude of the hand part 3 so that the reaction force from the placement surface T that acts on the finger tips of the respective finger parts 3a and 3b falls within an appropriate range.

For example, the controller 11 determines whether or not a difference between a right finger tip pressure sum value (RPSum) which is a pressure sum value of the second detection region 202 in a sensor part 20b of a right finger part 3b (R) and a left finger tip pressure sum value (LPSum) which is a pressure sum value of the second detection region 202 in a sensor part 20a of a left finger part 3a (L) has exceeded a predetermined positive pressure difference threshold (RL pressure difference threshold (+)) (Step 202). In a case where the difference has exceeded the RL pressure difference threshold (+), the controller 11 determines that the right finger part 3b (R) has received a pressure from the placement surface T with a larger force than that of the left finger part 3a (L) and outputs a control command for turning the hand part 3 around the Y-axis in a counter-clockwise direction (positive θ-direction) by a slight angle in FIG. 10 as the control command for controlling the attitude of the hand part 3 (Step 203).

On the other hand, the controller 11 determines whether or not a difference between the right finger tip pressure sum value (RPSum) and the left finger tip pressure sum value (LPSum) is smaller than a predetermined negative pressure difference threshold (RL pressure difference threshold (−)) (Step 204). In a case where the difference is smaller than the RL pressure difference threshold (−), the controller 11 determines that the left finger part 3a (L) has received a pressure from the placement surface T with a larger force than that of the right finger part 3b (R) and outputs a control command for turning the hand part 3 around the Y-axis in a clockwise direction (negative θ-direction) by a slight angle in FIG. 10 (Step 205). Accordingly, a difference in contact pressure between the left and right finger parts 3a and 3b with respect to the placement surface T can be maintained within a predetermined range.

Moreover, the controller 11 determines whether or not the difference between a right and left finger tip pressure sum value (RLPSum) which is the sum of the right finger tip pressure sum value (RPSum) and the left finger tip pressure sum value (LPSum) and its preset target value (RL pressure sum target value) is smaller than a predetermined negative pressure difference target threshold (RL pressure difference target threshold (−)) (Step 206). When the difference is smaller than an RLP pressure difference target value (−), the controller 11 determines that a contact pressure of the finger part 3a or 3b with respect to the placement surface T is too low and outputs a control command for moving the hand part 3 downwards (negative Z-direction) by a small distance (Step 207).

In addition, the controller 11 determines whether or not the difference between the right and left finger tip pressure sum value (RLPSum) and its target value (RL pressure sum target value) has exceeded a predetermined positive pressure difference target threshold (RL pressure difference target threshold (+)) (Step 208). When the difference has exceeded the RLP pressure difference target value (+), the controller 11 determines that the contact pressure of the finger part 3a or 3b with respect to the placement surface T is too high and outputs a control command for moving the hand part 3 upwards (positive Z-direction) by a small distance (Step 209).

The above-mentioned processing is repeated until it is determined that a pressure sum value of the first detection region 201 in the sensor part 20a or 20b of each finger part 3a or 3b has exceeded a predetermined threshold (Step 210). Accordingly, it is possible to maintain an attitude in which the finger parts 3a and 3b holding the workpiece W are held in uniform contact with the placement surface T with appropriate contact pressures. Then, in a case where it is determined that the pressure sum value of each first detection region 201 has exceeded the predetermined threshold (“Yes” in Step 210), the control unit 70 outputs a control command for stopping the movements of the finger parts 3a and 3b in the holding direction (X-axis direction) (Step 211).

Subsequently, the pickup operation for the workpiece W by the robot apparatus 10 is terminated by outputting the control command for moving the hand part 3 from the controller 11 upwards as shown in (D) of FIG. 10. Then, the robot apparatus 10 moves the hand part 3 while maintaining the holding operation for the workpiece W, such that the workpiece W is transported to the above-mentioned predetermined position.

In accordance with the present embodiment, the tip end regions 132 of the finger parts 3a and 3b are provided with the second detection regions 202 constituted by the pressure sensors that detect the contact with the placement surface T so that the amount of lowering of the hand part 3 is determined on the basis of their detection values. Therefore, it is possible to move the hand part 3 to above the placement surface T for the workpiece W with high accuracy. Accordingly, as compared to the case where the hand part is positioned by the use of an optical sensor such as a camera, it is possible to easily position the hand part 3 to the holding position and suitably hold the workpiece W with a simple configuration. Moreover, an optical sensor such as a camera is unnecessary, and therefore it is possible to control the movement of the hand part 3 without being limited by a working environment.

Moreover, in accordance with the present embodiment, the holding operation for the workpiece W is performed on the basis of the pressure detected by the sensor parts 20a and 20b. Therefore, also in a case where the workpiece W is constituted by a thin object like a plate, a deformable elastic body, a molded object having a non-uniform shape, or the like, it is possible to hold the workpiece with a suitable holding force.

### (Operation Example 2)

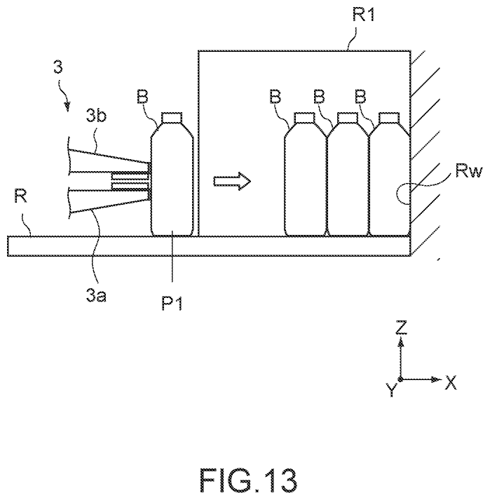

FIG. 13 is a schematic view describing an operation example that stores bottles B as workpieces in a storage space R1 on a rack R.

As shown in FIG. 13, the rack R is horizontally installed in parallel with the XY-plane. The robot apparatus moves the bottle B in the storage space R1 by the hand part 3 pushing in the bottle B arranged at an initial position P1 on the rack R toward the storage space R1 rightwards (positive X direction) in the figure. The bottles B are stored one by one to the front side from the deep side (wall part Rw side) in the storage space R1 when viewed from the movement direction (positive X direction) of the hand part 3.

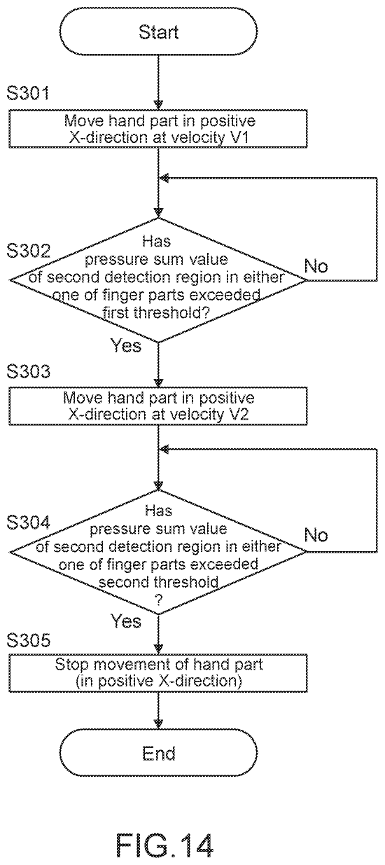

FIG. 14 is a flowchart showing an example of a processing procedure for executing the above-mentioned operation example in the control apparatus (the controller 11 and the control unit 70). Here, a control procedure for pushing in one bottle B in the storage space R1 from the initial position P1 outside the storage space R1 will be described.

Once the bottle B is arranged in the initial position P1, the controller 11 outputs a control command for moving the hand part 3 in the positive X direction at a velocity V1 from the left-hand side with respect to the initial position P1 (Step 301). The hand part 3 is retained in a horizontal attitude so that the finger parts 3a and 3b have their tip end portions oriented in the positive X direction. In this example, the two finger parts 3a and 3b push in the bottle B, though not limited thereto. Only one of the finger parts may push in the bottle B. Moreover, installation of the bottle B to the initial position P1 may be performed by the robot apparatus, may be performed by another robot apparatus, or may be performed by a serviceman.

The control unit 70 determines whether or not the sum of pressure values in the Z-axis direction detected by the second detection region 202 of the sensor part 20a or 20b in either one of the finger parts 3a and 3b has exceeded a predetermined first threshold (Step 302). This first threshold is not particularly limited as long as the value enables detection of the contact of the finger parts 3a and 3b with the bottle B.

In a case where the sum of pressure values has exceeded the first threshold (“Yes” in Step 302), considering that the hand part 3 has come into contact with the bottle B, the controller 11 outputs a control command for moving the hand part 3 in the positive X direction at a velocity V2 as the control command for controlling the movement of the hand part 3 (Step 303). Accordingly, the bottle B at the initial position P1 is pushed in toward the storage space R1 rightwards. The velocity V2 is not particularly limited as long as it is velocity changed from the velocity V1. Typically, the velocity V2 is set to be velocity lower than the velocity V1. Accordingly, it is possible to increase the access velocity to the bottle B by the hand part 3 and move the bottle B in a stable attitude.

Subsequently, the control unit 70 determines whether or not the sum of pressure values in the Z-axis direction detected by the second detection region 202 of the sensor part 20a or 20b in either one of the finger parts 3a and 3b has exceeded a predetermined second threshold (Step 304). This second threshold is not particularly limited as long as the value enables detection of a contact of the pushed-in bottle B with the deep wall part Rw in the storage space R1 or another bottle B in the storage space R1.

When the sum of pressure values has exceeded the second threshold (“Yes” in Step 304), the controller 11 outputs a control command for stopping the movement of the hand part 3 in the positive X direction (Step 305). Thereafter, a plurality of bottles B in the storage space R1 can be stored by repeatedly executing processing similar to that described above.

### Second Embodiment

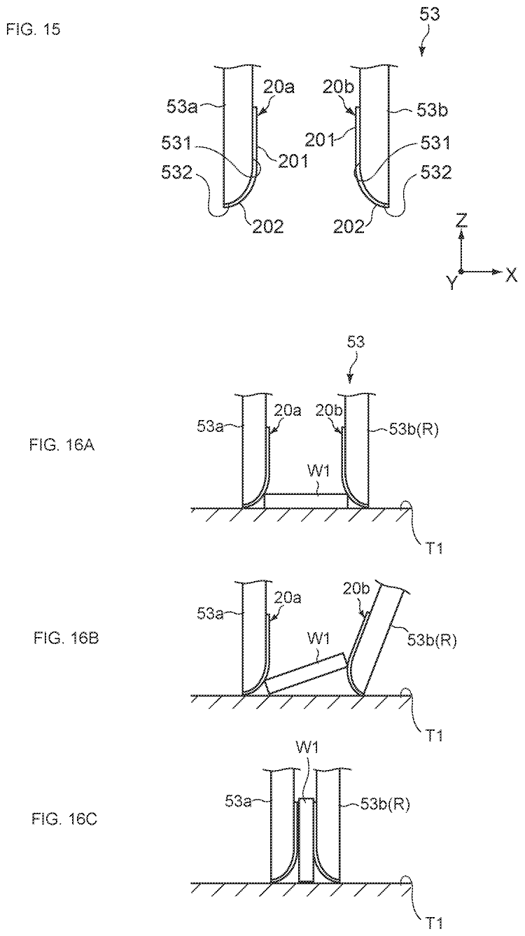

FIG. 15 is a schematic front view showing a configuration of a hand part of a robot apparatus according to a second embodiment of the present technology. Hereinafter, configurations different from those of the first embodiment will be mainly described, and configurations similar to those of the first embodiment will be denoted by similar reference signs and descriptions thereof will be omitted or simplified.

A hand part 53 according to the present embodiment is common to the first embodiment in that it has two finger parts 53a and 53b. However, the shapes of the finger parts 53a and 53b are different from those of the first embodiment. In the present embodiment, in each of the finger parts 53a and 53b, an area between a holding region 531 forming the holding surface and a tip end region 532 positioned at the finger tip is continuously formed as a continuous curved surface. The tip end region 532 is formed of a part of the curved surface and has a tapered shape toward the finger tip.

The sensor parts 20a and 20b are respectively provided to the finger parts 53a and 53b. The sensor parts 20a and 20b each include a first detection region 201 and a second detection region 202 as in the first embodiment. The first detection region 201 is arranged in the holding region 531. The second detection region 202 is arranged in the tip end region 532.

Since the holding region 531 and the tip end region 532 of each of the finger parts 53a and 53b are formed to be continuous to each other, the area between the first detection region 201 and the second detection region 202 is formed as a continuous curved surface also in each of the sensor parts 20a and 20b. The first detection region 201 primarily detects pressure components in the X-axis direction and the second detection region 202 primarily detects pressure components in the Z-axis direction. On the other hand, an intermediate region between the first detection region 201 and the second detection region 202 detects a resultant force of pressure components in the X-axis direction and pressure components in the Z-axis direction. That is, the intermediate region can be used as a detection region that supports both the first detection region 201 and the second detection region 202.

Also in the hand part 53 according to the present embodiment, an operation similar to that of the first embodiment can be performed. Moreover, since in the hand part 53 according to the present embodiment, the holding region 531 and the tip end region 532 of each of the finger parts 53a and 53b are continuously formed, an operation of turning over a workpiece W1 as shown in FIG. 16 can also be achieved.

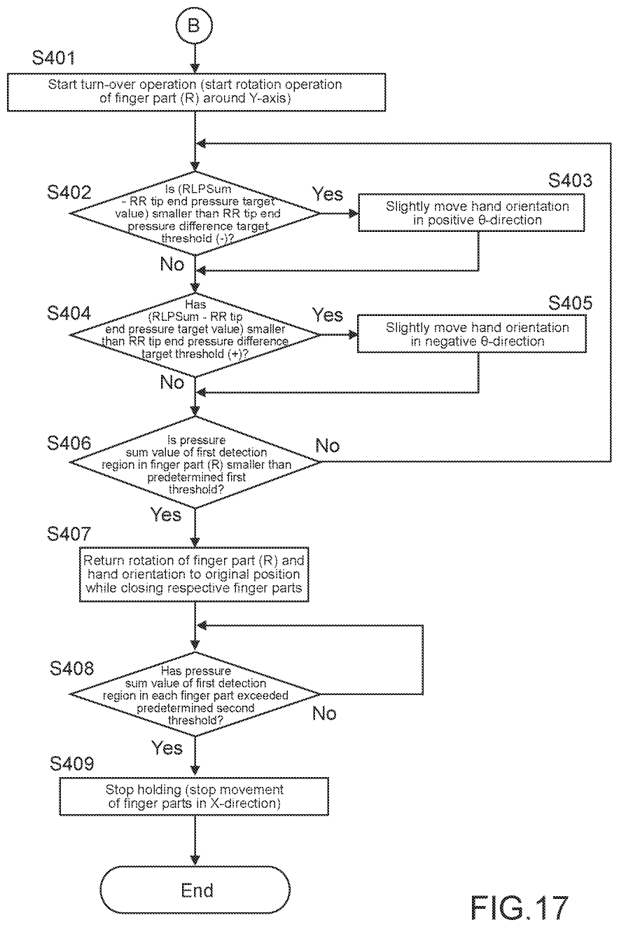

FIG. 16 is a main-part front view showing a procedure of the operation of turning over by the hand part 53 with respect to the workpiece W1 placed on a placement surface T1. FIG. 17 is a flowchart showing an example of a processing procedure executed in the control apparatus (the controller 11 and the control unit 70). Here, an operation example of turning a right finger part 53b, changing the workpiece W1 from a lying-down attitude to a standing attitude, and holding the workpiece W1 will be described.

(A) of FIG. 16 shows a state in which the finger parts 53a and 53b hold the workpiece W1. The holding operation for the workpiece W1 by the finger parts 53a and 53b is similar to that of the above-mentioned first embodiment ((C) of FIG. 10, Step 211 in FIG. 12), a description thereof will be omitted. It should be noted that the operation procedure of turning over the workpiece W1 is executed following the subsequent stage (Step B) of Step 211 in FIG. 12.

After holding the workpiece W1 with the two finger parts 53a and 53b above the placement surface T1, the controller 11 starts an operation of turning the right finger part 53b (R) around the Y-axis in the clockwise direction and turning over the workpiece W1 from the right end as shown in (B) of FIG. 16 (Step 401). At this time, on the basis of outputs from the second detection regions 202 of the sensor parts 20a and 20b, the controller 11 controls the attitude of the hand part 3 so that the reaction force from the placement surface T and the workpiece W1 that act on the finger tips of the respective finger parts 53a and 53b falls within an appropriate range.

For example, the controller 11 determines whether or not a difference between a right finger tip pressure sum value (RPSum) which is a pressure sum value of the second detection region 202 in the sensor part 20b of the right finger part 53b (R) and its preset target value (RR tip end pressure target value) is smaller than a predetermined negative pressure difference target threshold (RR tip end pressure difference target threshold (−)) (Step 402). In a case where the difference is smaller than the RR tip end pressure difference target threshold (−), the controller 11 determines that the reaction force from the placement surface T1 acting on the tip end portion of the right finger part 53b is excessively large and outputs a control command for turning the hand part 53 around the Y-axis in the counter-clockwise direction (positive θ-direction) by a slight angle in FIG. 16 (Step 403). Accordingly, it is possible to reduce a contact pressure of the right finger part 53b (R) with the placement surface T1 and smoothly perform a rotational operation of the finger part 53b (R).

On the other hand, the controller 11 determines whether or not the difference between the right finger tip pressure sum value (RPSum) and the RR tip end pressure target value has exceeded a predetermined positive pressure difference target threshold (RR tip end pressure difference target threshold (+)) (Step 404). In a case where the difference has exceeded the RR tip end pressure difference target threshold (+), the controller 11 determines that the reaction force from the placement surface T1 acting on the tip end portion of the right finger part 53b is excessively small and outputs a control command for turning the hand part 53 around the Y-axis in the clockwise direction (negative θ-direction) by a slight angle in FIG. 16 (Step 405). Accordingly, it is possible to ensure a sufficient contact pressure between the right finger part 53b (R) and the placement surface T1 and prevent the finger part 53b (R) from rising from the placement surface T1.

The above-mentioned processing is repeated until it is determined that a pressure sum value of the first detection region 201 in the sensor part 20b of the right finger part 53b (R) is smaller than a predetermined first threshold (Step 406). The first threshold is set to be a magnitude by which it can be determined that the workpiece W1 in a standing state with respect to the placement surface T1. In a case where the pressure sum value is smaller than the first threshold (“Yes” in Step 406), the controller 11 returns the right finger part 53b (R) and the hand part 53 to the original rotation position (the initial position before it turns) while closing the respective finger parts 53a and 53b (moving them in the holding direction) (Step 407).

Subsequently, as shown in (C) of FIG. 16, it is repeated until it is determined that the pressure sum value of the first detection region 201 in the sensor part 20a or 20b of each finger part 53a or 53b has exceeded a predetermined second threshold (Step 408). The second threshold is set to be a magnitude by which an appropriate holding force is obtained with respect to the workpiece W1 in the standing state. Then, in a case where it is determined that the pressure sum value of each first detection region 201 has exceeded the predetermined threshold (“Yes” in Step 408), the control unit 70 outputs a control command for stopping the movements of the finger parts 3a and 3b in the holding direction (X-axis direction) (Step 409).

As described above, the operation of turning over the workpiece W1 is performed. For turning over the workpiece W1 from the left end, it is sufficient to perform a rotational operation with the left finger part 53a as a target. In accordance with the present embodiment, the operation of turning over the workpiece W1 has been described. However, this technology can also be applied to a page turning-over operation for a book other than this.

### OTHER EMBODIMENTS

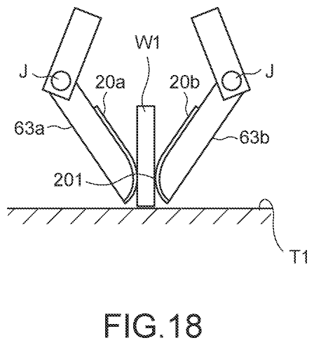

The configurations of the hand part are not limited to those described above in the first and second embodiments. For example, as schematically shown in FIG. 18, the hand part may be constituted by finger parts 63a and 63b with joint parts J. In this case, the respective finger parts 63a and 63b may hold the workpiece W1 in an attitude inclined with a predetermined angle with respect to the placement surface T1. In this case, in the example shown in the figure, holding regions of the respective finger parts 63a and 63b are provided in curved surface regions facing each other in the holding direction in the holding attitude and the first detection regions 201 of the sensor parts 20a and 20b are arranged in the curved surface regions.

Moreover, although the left and right finger parts 53a and 53b are respectively formed in similar shapes in the above-mentioned second embodiment, for example, the shape of the finger part 3a described above in the first embodiment may be employed for the left finger part 53a. That is, the configuration of the finger part described above in the second embodiment may be applied only to the finger part that is operated to turn when turning over the workpiece. The same applies to a case where three or more finger parts are provided. It should be noted that the present technology may also take the following configurations.

(1) A robot apparatus, including:
a hand part with a plurality of finger parts capable of holding a workpiece;
a plurality of sensor parts that is respectively provided to the plurality of finger parts and respectively has first detection regions capable of detecting pressure components parallel to a first axis direction which is a holding direction for the workpiece and second detection regions capable of detecting pressure components parallel to a second axis direction intersecting with the first axis direction; and
a control apparatus configured to generate a control command for controlling the hand part on the basis of outputs from the plurality of sensor parts.
   (2) The robot apparatus according to (1), in which
the plurality of finger parts respectively has flat surface or curved surface-shaped tip end regions positioned at finger tips and flat surface or curved surface-shaped holding regions that hold the workpiece, and
the first detection regions are respectively arranged at the tip end regions of the plurality of finger parts and the second detection regions are respectively arranged at the holding regions of the plurality of finger parts.
   (3) The robot apparatus according to (1) or (2), in which
at least one of the plurality of finger parts is configured to be capable of turning around a third axis orthogonal to each of the first axis and the second axis.
   (4) The robot apparatus according to any one of (1) to (3), in which
the plurality of sensor parts is respectively constituted by common sensor sheets having the first detection regions and the second detection regions in a plane.
   (5) The robot apparatus according to (4), in which
the sensor sheet is constituted by a pressure sensor including a sensor electrode layer having a plurality of capacitive elements arranged in a matrix form, a reference electrode layer connected to a reference potential, and a deformation layer arranged between the sensor electrode layer and the reference electrode layer.
   (6) The robot apparatus according to (4), in which
the sensor sheet includes
   a pair of pressure sensors respectively having a sensor electrode layer that has a plurality of capacitive elements arranged in a matrix form, a reference electrode layer connected to a reference potential, and a deformation layer arranged between the sensor electrode layer and the reference electrode layer, and
   a separation layer constituted by a viscoelastic material arranged between the pair of pressure sensors.
      (7) The robot apparatus according to any one of (1) to (6), in which
the control apparatus is configured to output a control command for controlling a movement of the hand part along the second axis direction on the basis of the outputs from the second detection regions.
   (8) The robot apparatus according to (7), in which
the control apparatus outputs a control command for stopping the movement of the hand part along the second axis direction as the control command.
   (9) The robot apparatus according to (7), in which
the control apparatus outputs a control command for changing a movement velocity of the hand part along the second axis direction as the control command.
   (10) The robot apparatus according to any one of (7) to (9), in which
the control apparatus is configured to output, when pressure values detected by the second detection regions in the plurality of finger parts are equal to or larger than a predetermined threshold, a control command for controlling an attitude of the hand part so that a difference between the pressure values detected by the second detection regions in the plurality of finger parts is equal to or smaller than a predetermined value.
   (11) The robot apparatus according to (10), in which
the control apparatus is configured to output a control command for moving the plurality of finger parts along the first axis direction while maintaining a state in which the difference between the pressure values detected by the second detection regions in the plurality of finger parts is equal to or smaller than the predetermined value.
   (12) The robot apparatus according to (11), in which
the control apparatus is configured to output a control command for raising the hand part when pressure values detected by the first detection regions between the plurality of finger parts are equal to or larger than a predetermined threshold.
   (13) The robot apparatus according to (11), in which
the control apparatus is configured to output, when the pressure values detected by the first detection regions between the plurality of finger parts are equal to or larger than a predetermined threshold, a control command for turning one finger part of the plurality of finger parts around a third axis orthogonal to each of the first axis and the second axis.
   (14) A control method for a robot apparatus including
a hand part with a plurality of finger parts capable of holding a workpiece, and
a plurality of sensor parts that is respectively provided to the plurality of finger parts and respectively has first detection regions capable of detecting pressure components parallel to a first axis direction which is a holding direction for the workpiece and second detection regions capable of detecting pressure components parallel to a second axis direction intersecting with the first axis direction, including:
moving the hand part in the second axis direction; and controlling a movement of the hand part along the second axis direction on the basis of the outputs from the second detection regions.
   (15) The control method for a robot apparatus according to (14), in which
the step of controlling the movement of the hand part includes stopping the movement of the hand part along the second axis direction.
   (16) The control method for a robot apparatus according to (14), in which
the step of controlling the movement of the hand part includes changing a movement velocity of the hand part along the second axis direction.
   (17) The control method for a robot apparatus according to any one of (14) to (16), further including
controlling, when pressure values detected by the second detection regions in the plurality of finger parts are equal to or larger than a predetermined threshold, an attitude of the hand part so that a difference between the pressure values detected by the second detection regions in the plurality of finger parts is equal to or smaller than a predetermined value.
   (18) The control method for a robot apparatus according to (17), further including
moving the plurality of finger parts along the first axis direction while maintaining a state in which the difference between the pressure values detected by the second detection regions in the plurality of finger parts is equal to or smaller than the predetermined value.
   (19) The control method for a robot apparatus according to (18), further including
raising the hand part when pressure values detected by the first detection regions between the plurality of finger parts are equal to or larger than a predetermined threshold.
   (20) The control method for a robot apparatus according to (18), further including
turning, when the pressure values detected by the first detection regions between the plurality of finger parts are equal to or larger than a predetermined threshold, one finger part of the plurality of finger parts around a third axis orthogonal to each of the first axis and the second axis.

### REFERENCE SIGNS LIST

3a, 3b, 53a, 53b finger part
10 robot apparatus
11 controller
12 drive part
12a drive unit
20a, 20b sensor part
21 sensor part
23 separation layer
25 reference electrode layer
27 deformation layer
28 sensing part
30 sensor electrode layer
70 control unit
131, 531 holding region
132, 532 tip end region
201 first detection region
202 second detection region
210, 220 sensor sheet
W, W1 workpiece

1. A robot apparatus, comprising:
a hand part with a plurality of finger parts capable of holding a workpiece;
a plurality of sensor parts that is respectively provided to the plurality of finger parts and respectively has first detection regions capable of detecting pressure components parallel to a first axis direction which is a holding direction for the workpiece and second detection regions capable of detecting pressure components parallel to a second axis direction intersecting with the first axis direction; and
a control apparatus configured to generate a control command for controlling the hand part on a basis of outputs from the plurality of sensor parts.

2. The robot apparatus according to claim 1, wherein
the plurality of finger parts respectively has flat surface or curved surface-shaped tip end regions positioned at finger tips and flat surface or curved surface-shaped holding regions that hold the workpiece, and
the first detection regions are respectively arranged at the tip end regions of the plurality of finger parts and the second detection regions are respectively arranged at the holding regions of the plurality of finger parts.

3. The robot apparatus according to claim 1, wherein
at least one of the plurality of finger parts is configured to be capable of turning around a third axis orthogonal to each of the first axis and the second axis.

4. The robot apparatus according to claim 1, wherein
the plurality of sensor parts is respectively constituted by common sensor sheets having the first detection regions and the second detection regions in a plane.

5. The robot apparatus according to claim 4, wherein
the sensor sheet is constituted by a pressure sensor including a sensor electrode layer having a plurality of capacitive elements arranged in a matrix form, a reference electrode layer connected to a reference potential, and a deformation layer arranged between the sensor electrode layer and the reference electrode layer.

6. The robot apparatus according to claim 4, wherein
the sensor sheet includes
a pair of pressure sensors respectively having a sensor electrode layer that has a plurality of capacitive elements arranged in a matrix form, a reference electrode layer connected to a reference potential, and a deformation layer arranged between the sensor electrode layer and the reference electrode layer, and
a separation layer constituted by a viscoelastic material arranged between the pair of pressure sensors.

7. The robot apparatus according to claim 1, wherein
the control apparatus is configured to output a control command for controlling a movement of the hand part along the second axis direction on a basis of the outputs from the second detection regions.

8. The robot apparatus according to claim 7, wherein
the control apparatus outputs a control command for stopping the movement of the hand part along the second axis direction as the control command.

9. The robot apparatus according to claim 7, wherein
the control apparatus outputs a control command for changing a movement velocity of the hand part along the second axis direction as the control command.

10. The robot apparatus according to claim 7, wherein
the control apparatus is configured to output, when pressure values detected by the second detection regions in the plurality of finger parts are equal to or larger than a predetermined threshold, a control command for controlling an attitude of the hand part so that a difference between the pressure values detected by the second detection regions in the plurality of finger parts is equal to or smaller than a predetermined value.

11. The robot apparatus according to claim 10, wherein
the control apparatus is configured to output a control command for moving the plurality of finger parts along the first axis direction while maintaining a state in which the difference between the pressure values detected by the second detection regions in the plurality of finger parts is equal to or smaller than the predetermined value.

12. The robot apparatus according to claim 11, wherein
the control apparatus is configured to output a control command for raising the hand part when pressure values detected by the first detection regions between the plurality of finger parts are equal to or larger than a predetermined threshold.

13. The robot apparatus according to claim 11, wherein
the control apparatus is configured to output, when the pressure values detected by the first detection regions between the plurality of finger parts are equal to or larger than a predetermined threshold, a control command for turning one finger part of the plurality of finger parts around a third axis orthogonal to each of the first axis and the second axis.

14. A control method for a robot apparatus including
a hand part with a plurality of finger parts capable of holding a workpiece, and
a plurality of sensor parts that is respectively provided to the plurality of finger parts and respectively has first detection regions capable of detecting pressure components parallel to a first axis direction which is a holding direction for the workpiece and second detection regions capable of detecting pressure components parallel to a second axis direction intersecting with the first axis direction, comprising:
moving the hand part in the second axis direction; and
controlling a movement of the hand part along the second axis direction on a basis of the outputs from the second detection regions.

15. The control method for a robot apparatus according to claim 14, wherein
the step of controlling the movement of the hand part includes stopping the movement of the hand part along the second axis direction.

16. The control method for a robot apparatus according to claim 14, wherein
the step of controlling the movement of the hand part includes changing a movement velocity of the hand part along the second axis direction.

17. The control method for a robot apparatus according to claim 14, further comprising
controlling, when pressure values detected by the second detection regions in the plurality of finger parts are equal to or larger than a predetermined threshold, an attitude of the hand part so that a difference between the pressure values detected by the second detection regions in the plurality of finger parts is equal to or smaller than a predetermined value.

18. The control method for a robot apparatus according to claim 17, further comprising
moving the plurality of finger parts along the first axis direction while maintaining a state in which the difference between the pressure values detected by the second detection regions in the plurality of finger parts is equal to or smaller than the predetermined value.

19. The control method for a robot apparatus according to claim 18, further comprising
raising the hand part when pressure values detected by the first detection regions between the plurality of finger parts are equal to or larger than a predetermined threshold.

20. The control method for a robot apparatus according to claim 18, further comprising
turning, when the pressure values detected by the first detection regions between the plurality of finger parts are equal to or larger than a predetermined threshold, one finger part of the plurality of finger parts around a third axis orthogonal to each of the first axis and the second axis.
